(19) United States
(12) Patent Application Publication
(10) Pub. No.: US 2023/0045229 A1
(43) Pub. Date: Feb. 9, 2023

(54) Method and System for Conflict Resolution in Multi-User Document Collaboration

(71) Applicant: Klaviyo, Inc, Boston, MA (US)

(72) Inventors: Nikita Shenkman, Boston, MA (US); Daniel Kezerashvili, Boston, MA (US); Shresth Bhatnagar, Boston, MA (US)

(73) Assignee: Klaviyo, Inc, Boston, MA (US)

(21) Appl. No.: 17/538,656

(22) Filed: Nov. 30, 2021

Related U.S. Application Data
(60) Provisional application No. 63/227,848, filed on Jul. 30, 2021.

(51) Int. Cl. G06F 40/186; G06F 16/176; G06F 40/197; G06F 3/0486

(52) U.S. Cl. CPC G06F 40/186; G06F 16/1767; G06F 40/197; G06F 3/0486

(57) ABSTRACT

Methods and systems for implementing a conflict resolution process in real-time editing of an online document by multiple users are provided. By adopting a multi-user conflict ID, the system can determine whether an editing conflict exists between two users' modifications of the same document. It can further generate a corresponding conflict resolution action based on a resolution model and synchronize multi-user modifications via serialization data. By enabling multiple users to collaboratively edit one document, e.g., an email, the present methods and systems can effectively optimize the workflow and efficiency of a team.

### CROSS-REFERENCES TO RELATED APPLICATIONS

This application claims the benefit of U.S. Provisional Patent Application No. 63/227,848, entitled “Method and System for Conflict Resolution in Multi-user Document Collaboration,” filed Jul. 30, 2021, which is incorporated herein by reference for all purposes.

### TECHNICAL FIELD

The present subject matter is in the field of online document collaboration. More particularly, embodiments of the present subject matter relate to a method and system for allowing multiple users to edit one document, e.g., an email, in real-time.

### BACKGROUND

Technologies enabling joint editing of the same document have become increasingly important. There are a lot of needs to improve such technologies as various modifications from different users can create incompatible versions of the document. For example, the different versions of the document can create confusion and make them difficult to track or combine.

### SUMMARY OF THE INVENTION

The present subject matter pertains to improved approaches for real-time, multi-user editing of a document by implementing a conflict resolution model. Specifically, systems and methods of the present subject matter can determine whether an editing conflict exists via a multi-user conflict ID. The systems and methods can further determine a conflict resolution action based on a conflict resolution model as described herein. The present subject matter can synchronize multi-user modifications via serialization data which enables multiple users to effectively collaborate on one document, such as an email.

According to some embodiments, systems and methods of the present subject matter can generate serialized data of the template, e.g., via JSON (JavaScript Object Notation) strings. Furthermore, the system can utilize serialization to convert an object into data strings and deserialization to convert strings into objects.

According to some embodiments, a computer-implemented method for multi-user document editing comprises receiving, at a first client device, a base template from a service provider, wherein the base template is associated with a proposed first multi-user conflict ID assigned for a first save event, modifying, at the first client device, the base template with a first user modification to generate a first template associated with the proposed first-user conflict ID, transmitting the first template and the proposed first multi-user conflict ID to the service provider, determining, at the service provider, whether an editing conflict exists between the first user modification and a second user modification based on whether the proposed first multi-user ID is lower than an assigned multi-user conflict ID, and receiving, from the service provider, at least one of: when the proposed first multi-user ID is the same as the assigned multi-user conflict ID, a confirmation of the proposed first multi-user conflict ID, or when the proposed first multi-user ID is lower than the assigned multi-user conflict ID, a rejection of the proposed first multi-user conflict ID and an updated base template with serialization data in association with the assigned multi-user conflict ID.

According to some embodiments, a computer-implemented method for multi-user document editing comprises: displaying, by a service provider, a base template on a plurality of client devices, wherein the base template is associated with a first multi-user conflict ID assigned for a first save event, receiving, from a first client device, a first user modification of the base template configured to trigger the first save event, updating, at the service provider, the base template to generate a first template associated with the first multi-user conflict ID and incrementally generating a second multi-user conflict ID based on the first multi-user conflict ID, wherein the second multi-user conflict ID is assigned for a second save event, receiving, from a second client device, a second user modification of the base template to trigger an attempted second save event, wherein the second user modification is associated with a proposed multi-user conflict ID, determining an editing conflict exists between the first user modification and the second user modification based on whether the proposed multi-user conflict ID is lower than the second multi-user conflict ID, and determining, when the editing conflict exists, at least one conflict resolution action at least based on a conflict resolution model; and implementing the at least one conflict resolution action.

According to some embodiments, the method further comprises transmitting the first template associated with the first multi-user conflict ID to the first client device. According to some embodiments, the at least one conflict resolution comprises one of a conflict warning that disregards the second user modification, an acceptance of the second user modification, and an option for action selection by a user.

According to some embodiments, when the editing conflict is resolvable, updating the first template to generate a second template associated with the second multi-user conflict ID and incrementally generating a third multi-user conflict ID based on the second multi-user conflict ID, wherein the third multi-user conflict ID is assigned for a third save event, and transmitting the second template associated with the second multi-user conflict ID to the second client device associated with the second user modification.

According to some embodiments, when the editing conflict is unresolvable, rejecting the second user modification and transmitting the first template associated with the first multi-user conflict ID to the second client device associated with the second user modification.

According to some embodiments, the method further comprises displaying a plurality of templates in a template editor and enabling a drag-and-drop of a selected template from the plurality of templates as the base template.

According to some embodiments, the method further comprises, during a save event, partially locking at least one block edition in the base template displayed on the plurality of client devices, wherein the at least one block edition comprises an addition, a deletion, or a move of a block and a block setting edition. In addition, the method further comprises, during the save event, partially allowing at least one minor block edition in the base template, wherein the at least one minor block edition comprises an edition of a block. According to some embodiments, the method further comprises tracking, timestamping and serializing each change applying to the base template.

According to some embodiments, a computer-implemented method for multi-user document editing comprises: displaying, by a service provider, a base template on a plurality of client devices, receiving, from a first client device, a first user modification of the base template configured to trigger a first save event, updating the base template to generate a first template, transmitting the first template to the first client device, receiving, from a second client device, a second user modification of the base template to trigger an attempted second save event, determining an editing conflict exists between the first user modification and the second user modification, determining at least one conflict resolution action at least based on a conflict resolution model; and implementing the at least one conflict resolution action. According to some embodiments, the base template comprises one or more blocks representing a structure of an email.

According to some embodiments, the at least one conflict resolution comprises one of a conflict warning that disregards the second user modification, an acceptance of the second user modification, and an option for action selection by a user.

According to some embodiments, the method further comprises, when the editing conflict is resolvable, updating the first template to generate a second template, and transmitting the second template to the second client device associated with the second user modification.

According to some embodiments, the method further comprises, when the editing conflict is unresolvable, rejecting the second user modification and transmitting the first template to the second client device associated with the second user modification.

According to some embodiments, the method further comprises displaying a plurality of templates in a template editor and enabling a drag-and-drop of a selected template from the plurality of templates as the base template.

According to some embodiments, the method further comprises during a save event, partially locking at least one block edition in the base template displayed on the plurality of client devices, wherein the at least one block edition comprises an addition, a deletion, or a move of a block and a block setting edition.

Other aspects and advantages of the present subject matter will become apparent from the following detailed description taken in conjunction with the accompanying drawings, which illustrate, by way of example, the principles of the present subject matter.

### DESCRIPTION OF DRAWINGS

The present subject matter is illustrated by way of example, and not by way of limitation, in the figures of the accompanying drawings and in which:

FIG. 1 shows a system that is configured to implement a conflict resolution in multi-user joint editing of a document, according to some implementations of the present subject matter;

FIG. 2 shows an exemplary user interface to create a base template using a template editor, according to some implementations of the present subject matter;

FIG. 3 shows another exemplary user interface to edit a base template using a template editor, according to some implementations of the present subject matter;

FIG. 4 shows an exemplary user interface showing partial components of a template editor, according to some implementations of the present subject matter;

FIG. 5 shows an exemplary user interface showing a block setting, according to some implementations of the present subject matter;

FIG. 6 is an exemplary conflict action table for multi-user editing, which illustrates features consistent with some implementations of the present subject matter;

FIG. 7 is an exemplary database consistent with some implementations of the present subject matter;

FIG. 8 is an exemplary view of a document with multi-user editing, which illustrates features consistent with some implementations of the present subject matter;

FIGS. 9A, 9B and 9C are exemplary views of a document with multi-user editing, which illustrates features consistent with some implementations of the present subject matter;

FIG. 10 is an exemplary flow diagram illustrating aspect of a method having features consistent with some implementations of the present subject matter;

FIG. 11A shows a cloud server according to one or more embodiments of the present subject matter;

FIG. 11B shows a diagram of a cloud server according to one or more embodiments of the present subject matter;

FIG. 12A shows a packaged system-on-chip according to one or more embodiments of the present subject matter;

FIG. 12B shows a diagram of a system-on-chip according to one or more embodiments of the present subject matter; and

FIG. 13 shows a non-transitory computer-readable medium according to one or more embodiments of the present subject matter.

### DETAILED DESCRIPTION

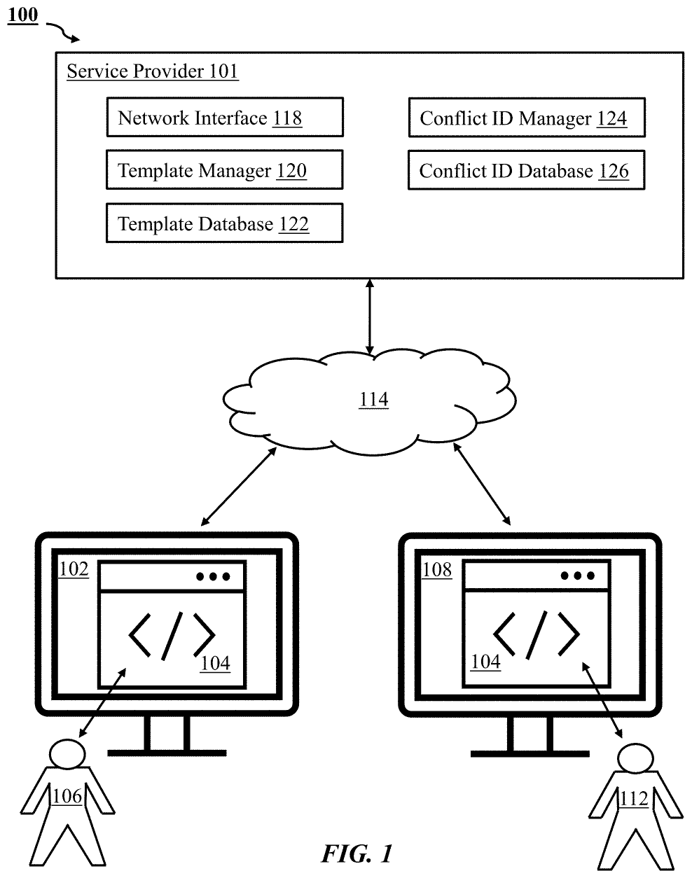

The present subject matter pertains to improved approaches to enable joint, real-time editing of a document, e.g., an email, by several users via multiple client devices. Embodiments of the present subject matter are discussed below with reference to FIGS. 1-13.

In the following description, for purposes of explanation, numerous specific details are set forth in order to provide a thorough understanding of the present subject matter. It will be apparent, however, to one skilled in the art that the present subject matter may be practiced without some of these specific details. In addition, the following description provides examples, and the accompanying drawings show various examples for the purposes of illustration. Moreover, these examples should not be construed in a limiting sense as they are merely intended to provide examples of embodiments of the subject matter rather than to provide an exhaustive list of all possible implementations. In other instances, well-known structures and devices are shown in block diagram form in order to avoid obscuring the details of the disclosed features of various described embodiments.

FIG. 1 shows a system that is configured to implement a conflict resolution in multi-user simultaneous editing of a document, according to some implementations of the present subject matter. A system 100 is configured to enable two or more users, e.g., first user 106 and second user 112, to independently and simultaneously edit a document via different computing devices, e.g., first computing device 102 and second computing device 108.

Network 114 can comprise a single network or a combination of multiple networks, such as the Internet or intranets, wireless cellular networks, local area network (LAN), wide area network (WAN), WiFi, Bluetooth, etc. Network 114 can comprise a mixture of private and public networks, or one or more local area networks (LANs) and wide-area networks (WANs) that may be implemented by various technologies and standards.

First computing device 102 or second computing device 108 can be any computing device that can be used to create and edit a document, e.g., a marketing email. Examples of computing devices 102 or 108 include a desk computer, a portable computer, an iPad, etc. Computing device 102 or 108 can have at least one display, at least one input/output device, and at least one network interface configured to connect to network 114.

Service provider 101 can be one or more host servers executing applications or codes to implement functions as described herein. According to some embodiments, service provider 101 can comprise network interface 118, template manager 120, template database 122, conflict ID manager 124 and conflict ID database 126. According to some embodiments, service provider 101 can be implemented by one or more servers within a cloud-processing structure, such as by a third-party service provider through a web API.

According to some embodiments, first user 106 can edit an email 104 via first computing device 102. At the same time, second user 112 can edit the same email 103 via second computing device 108. According to some embodiments, a potential edition conflict can occur with the simultaneous editing by the two users. For example, first user 106 has deleted a block in email 104. Without knowing about the delete, second user 112 attempts to move the same block in email 104. According to the present subject matter, the system can generate a conflict resolution action based on a conflict model as described herein. Examples of a conflict resolution action can be a denial of a second action, an implementation of a second action, an option that prompts a user to choose a preferred action.

For example, in response to second user 112's attempted edition, the system can generate a warning and display it to second user 112, such as “this block has been deleted by another user.” Accordingly, the attempted “move” action by second user 112 is denied by service provider 101. In addition, the template associated with second computing device 108 is updated by service provider 101 to reflect the earlier modification by first computing device 102, e.g., the block deletion by first user 106.

In another example, a second user's edition can be consequently adopted when it is determined that there is no conflict with a first action. Yet in another example, a second user is provided with an option of whether to implement his/her action or to keep the first user's edition. For example, the system can display, to the second user, that a block has been moved to a new position by another user, and prompt the second user to choose whether to implement his/her action that would overwrite the first user's block modification.

According to some embodiments, service provider 101 can adopt a multi-user conflict ID to manage the potential conflict resolution. According to some embodiments, the multi-user conflict ID can be sequentially increment interchange control numbers, such as an incremental interchanger, which can be used for tracking the various updates of a base template. According to some embodiments, the multi-user conflict ID can be sequentially decrement numbers. Following a save event, service provider 101 can automatically and incrementally assign an anticipated multi-user conflict ID based on the previous multi-user conflict ID for the next save event.

After receiving the next attempt to save an event associated with a proposed multi-user conflict ID, service provider 101 can determine whether an editing conflict exists between the two modifications based on whether the proposed multi-user conflict ID is lower than the preassigned, anticipated multi-user conflict ID. When the proposed ID is lower than the preassigned multi-user conflict, service provider 101 can determine that a potential conflict exists and initiate a conflict resolution process as described herein. When the proposed multi-user conflict ID is the same as the preassigned multi-user conflict, service provider 101 can determine that no potential conflict exists and implement the proposed save event.

According to some embodiments, service provider 101 can generate and store serialized data of the template, e.g., via JSON strings. Furthermore, service provider 101 can utilize serialization to convert an object into data strings and deserialization to convert strings into objects, both of which are utilized to synchronize and update the different template copies at various client devices.

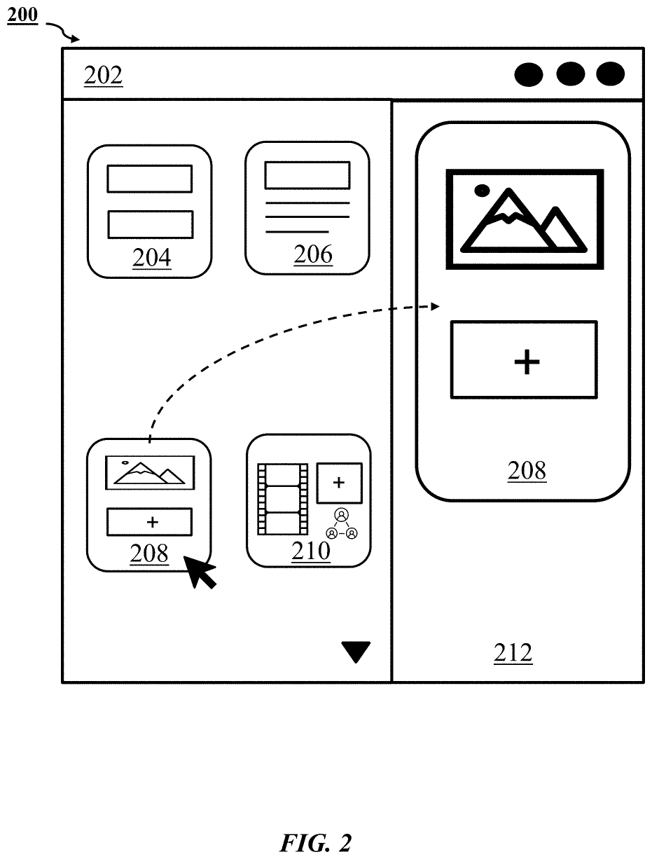

FIG. 2 shows an exemplary user interface 200 to create a base template using a template editor 202, according to some implementations of the present subject matter. As shown in FIG. 2, an email service provider is configured to display template editor 202 on a display of a computing device. Template editor 202 can provide an optimized process for generating effective and appealing emails in a marketing campaign.

According to some embodiments, template editor 202 can comprise one or more pre-generated base templates 204, 206, 208 and 210, which are configured to reduce time building a campaign or flow emails. Each of the base templates can feature different designs and themes, for example, to promote goods and services for different customer groups. By selecting a preferred base template 208, a user can “drag-and-drop” base template 208 to a blank editor space 212, or a canvas, which forms the basis of an email campaign. Based on a selected base template, a user can, for example, add a text or image block to show relevant information, use the header/link bar or social links block to redirect customers to a certain webpage or add in a product block to drop in a most popular product.

According to some embodiments, a user can create his/her own base template. A saved base template can be used as a starting point for future emails. Furthermore, an email template can be generated either directly in the template editor or by editing saved email templates.

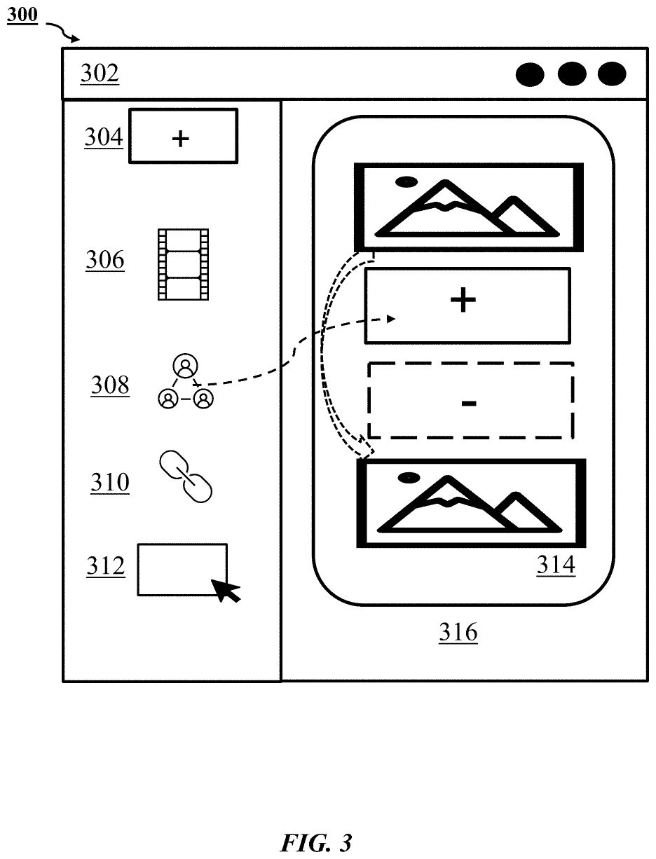

FIG. 3 shows another exemplary user interface 300 to edit a base template using a template editor 302, according to some implementations of the present subject matter. Following a selection of base template 314 in email canvas 316 as described in FIG. 2, a user can further modify the template using template editor 302.

According to some embodiments, various blocks can be used to generate an email. A block is a data object that comprises a group, a section, etc. A block can be a text block, an image block, a button block, a table block, a header/link bar block, a social link block, or any combination thereof. According to some embodiments, a block's style can be adjusted based on a user's preference. For example, a user can change the different visual representations of a block, including borders, colors, padding, margins, text font and weight, etc.

A text block 304 can be used to insert any text into an email. Text block 304 can allow a user to customize the text in base template 314. According to some embodiments, a user can edit the source or HTML code of text block 304 via directly editing the source file. In addition to the common block style, a user can further change font size, font weight, line height, and background of text block 304.

An image block 306 can be used to insert an image into an email. Image block 306 can be static or dynamic, such as a video. Various methods can be used to add an image to the image block, including uploading or dragging an image from a user's computer, inserting an image URL. In addition to the common block style, an image block can have some extra options such as background, border, and padding.

A social link block 308 can be used to add social icons for various social sites such as Facebook, Twitter, Pinterest, etc. When a user selects and drags social link block 308, the system will automatically populate a social icon as a default. For additional social sites, the user can add preferred social sites via a button block.

A header/link bar block 310 can be used to add a logo navigation link that can redirect to the different content of a user's website. According to some embodiments, when a user selects and drags header/link bar block 310, the system can populate several common header/link bar layouts to choose from. After selecting a preferred layout, the user can define the content of the block or adjust its look. According to some embodiments, other types of blocks, such as a table block, product block, columns, etc., can be used to create a customized email by the user.

A button block 312 can create larger links that are more obvious and are used for calls to action (CTAs). An example of a button block is for “Make Your Purchase.” The text and style of a button block can be edited by the user.

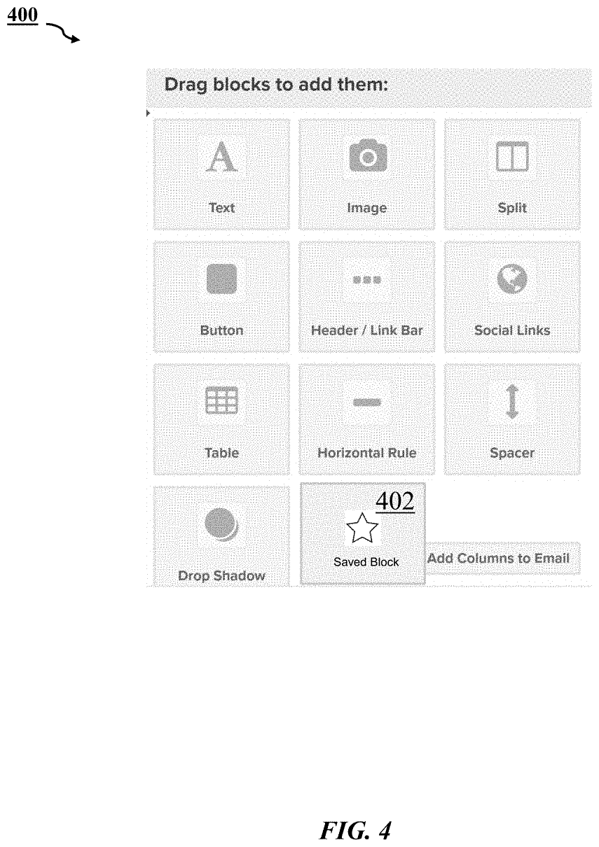

FIG. 4 shows an exemplary user interface 400 showing partial components of a template editor, according to some implementations of the present subject matter. As shown in FIG. 4, a template editor can comprise various blocks for editing a base template. According to some embodiments, the template editor can comprise, for example, a text block, an image block, a split column block, a button block, a header/link bar block, a social links block, a table block, a horizontal rule block, a spacer block, and a drop shadow block. According to some embodiments, the template editor can save a frequently used block as a saved block or a universal block.

For example, a saved block 402 or a universal block can be created by the user for future uses. A saved block enables a user to save a specific block within a template for future reuse. For example, a header or a footer block in a customized email template can be a saved block to avoid recreating it from scratch in every new email. Furthermore, a saved block can be named and stored in a folder for easy identification and access. According to some embodiments, a user can copy, delete, save and move a block.

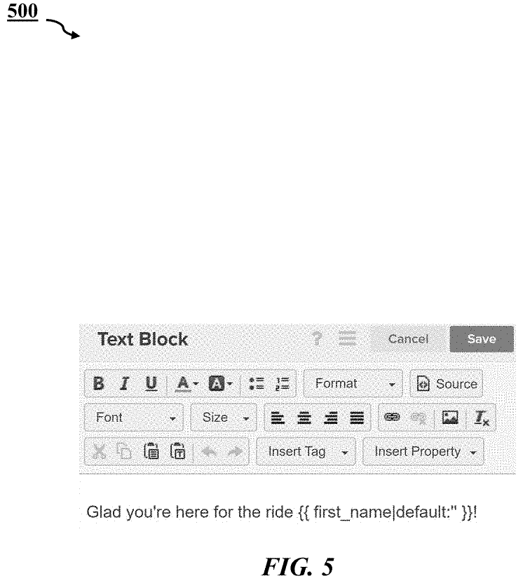

FIG. 5 shows an exemplary user interface showing a block setting 500, according to some implementations of the present subject matter. A block setting 500 is a sidebar or a toolbar associated with a block. It can be used to modify the content and style of a selected block. According to some embodiments, different types of blocks can have different block settings, depending on the available options for a block. For example, a text block's setting can be different from an image block's setting.

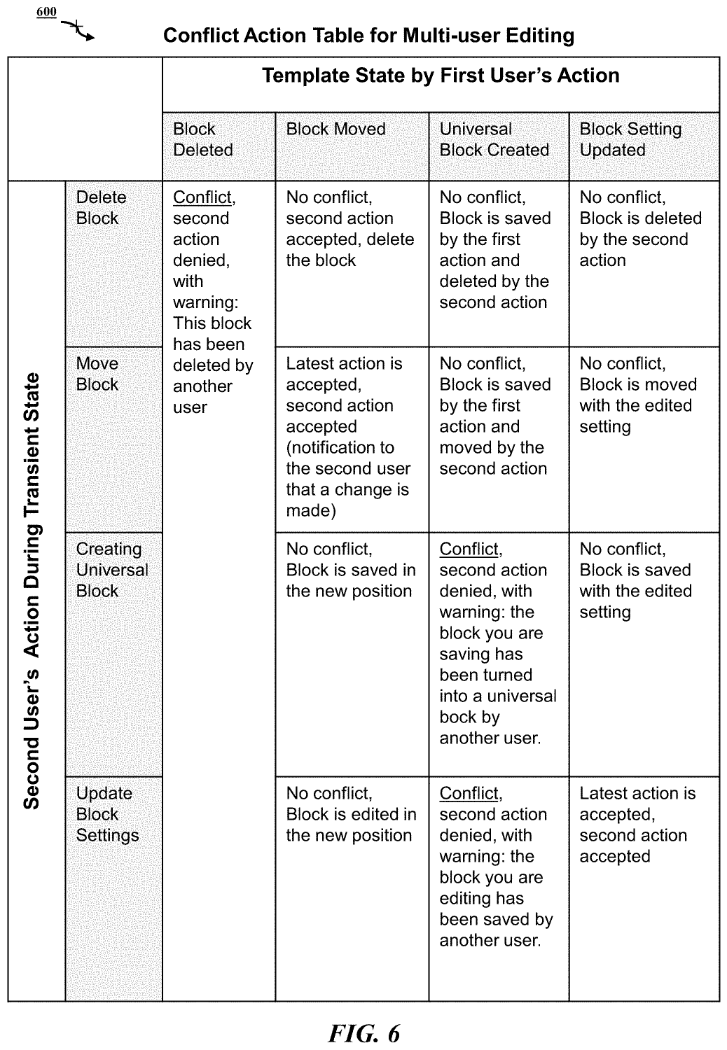

FIG. 6 is an exemplary conflict action table for multi-user editing, which illustrates features consistent with some implementations of the present subject matter. As shown in the conflict action table, a first user and a second user can co-edit a base template, e.g., an email, as illustrated earlier.

Conflict Action Table for Multi-user Editing (FIG. 6)

| | | Template State by First User's Action | | | |
|---|---|---|---|---|---|
| | | | | | Block |
| | | Block | | Universal Block | Setting |
| | | Deleted | Block Moved | Created | Updated |
| Second | Delete | Conflict, | No conflict, | No conflict, Block | No |
| User's | Block | second | second action | is saved by the | conflict, |
| Action | | action | accepted, delete | first action and | Block is |
| During | | denied, with | the block | deleted by the | deleted by |
| Transient | | warning: | | second action | the second |
| State | | This block | | | action |
| | | has been | | | |
| | | deleted by | | | |
| | | another user | | | |
| | Move | | Latest action is | No conflict, Block | No |
| | Block | | accepted, | is saved by the | conflict, |
| | | | second action | first action and | Block is |
| | | | accepted | moved by the | moved |
| | | | (notification to | second action | with the |
| | | | the second user | | edited |
| | | | that a change is | | setting |
| | | | made) | | |
| | Creating | | No conflict, | Conflict, second | No |
| | Universal | | Block is saved | action denied, | conflict, |
| | Block | | in the new | with warning: the | Block is |
| | | | position | block you are | saved with |
| | | | | saving has been | the edited |
| | | | | turned into a | setting |
| | | | | universal bock by | |
| | | | | another user. | |
| | Update | | No conflict, | Conflict, second | Latest |
| | Block | | Block is edited | action denied, | action is |
| | Settings | | in the new | with warning: the | accepted, |
| | | | position | block you are | second |
| | | | | editing has been | action |
| | | | | saved by another | accepted |
| | | | | user. | |

As shown in FIG. 6, according to some embodiments, a conflict resolution model can be generated based on the logic of the conflict action table. The conflict resolution computing model, for example, can comprise algorithms, programs, and codes to determine the conflict resolution as described herein. According to some embodiments, at least part of the conflict resolution model can be implemented by one or more servers within a cloud-processing structure, such as by a third-party service provider through a web API. According to some embodiments, at least part of the conflict resolution model can be implemented by a “local” computing device located in a private network or by a hybrid processing structure.

According to some embodiments, after a block has been first deleted by a first user, upon an attempted edition of a second user, the service server can determine that a conflict exists between the two users' actions/editions. It can deny an attempted second user action, e.g., delete, move, create a universal/saved block, update block settings. Furthermore, the service server can generate and display a warning on the second user's computing device. For example, the warning can be “this block has been deleted by another user.” Following the warning and denial, the updated base template without the deleted block can be displayed on a computing device for the second user.

According to some embodiments, after a block has been moved by a first user, upon an attempted second action of a second user, the service server can determine that there is no conflict between the two users' actions/editions. Accordingly, the second action can be adopted following the first action. For example, after a first user moves a block, a second user can delete it or move it again. The second user can also create a universal/saved block following the first user's move. The second user can also update a block setting following the first user's move.

According to some embodiments, after a block has been saved as a universal/saved block by a first user, upon an attempted second action of a second user, the service server can determine that there is a potential conflict between the two users' actions/editions. For example, following the first user's creation of a universal/saved block, when the second user's action is to delete or move the block, there is no conflict between the two users. As a result, the block that has been saved by the first user can be deleted or moved by the second user.

On the other hand, when the second user's action is to create another saved block or to update a block setting, the service server can determine that a conflict exists between the two users' actions. As a result, the second user action can be denied. According to some embodiments, a warning message can be displayed on the second computing device, e.g., “The block you are saving has been turned into a saved/universal block by another use,” or “The block you are editing has been saved by another user.”

According to some embodiments, after a block setting has been modified by a first user, upon an attempted second action of a second user, the service server can determine that no conflict exists between the users' actions/editions. For example, following a first user's modification of a block setting, a second user can delete, move or create a saved/universal block without conflict. In addition, the second user can further change the block's setting following the first user's change of the block setting.

According to some embodiments, besides the explicit actions as listed in the conflict action table of FIG. 6 that can trigger the conflict action resolution process, other implied “save” event can trigger the process, e.g., the execution of the conflict resolution model to determine whether a conflict exists between the two users' simultaneous actions. For example, a first user can edit a block setting, e.g., change font size of a text block, and then move away from the editing without saving it. Such an edition is considered an implicit action that would trigger a save event for the base template. On the other hand, some minor changes or actions by a user would not trigger a save event for the base template.

According to some embodiments, during a save event, the service provider can partially “freeze” a portion of the base template as displayed on each user's computing device. Such a “freeze” renders a certain portion of the base template not editable. This would prevent the corruption of metadata associated with the base template. According to some embodiments, the service provider can still partially allow minor editions of blocks that are not impacted by the save event or do not change metadata.

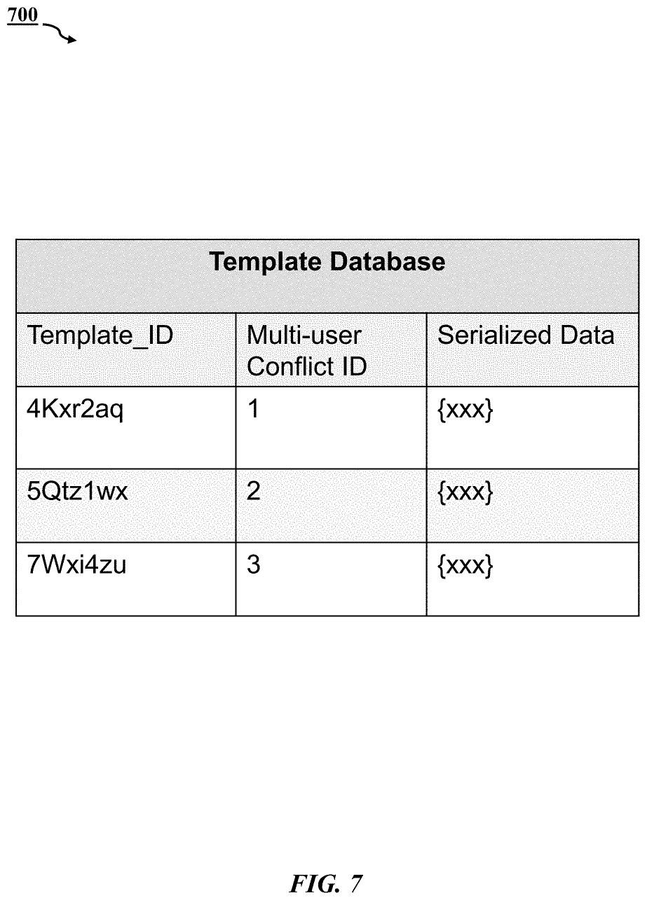

FIG. 7 is an exemplary template database 700 consistent with some implementations of the present subject matter. A service provider can manage the template database 700 by saving, retrieving and updating relevant data.

According to some embodiments, as shown in FIG. 7, a multi-user conflict ID can be adopted to facilitate the conflict action resolution process. For example, the service provider can associate a base template, e.g., template serial No. 4Kxr2aq, with a first multi-user conflict ID, e.g., 1, which is assigned for an expected first save event. After receiving a first user modification of the base template that is configured to trigger the save event at the service provider, the service provider can update the base template to an updated template, e.g., template serial No. 5Qtz1wx.

Meanwhile, the service provider can incrementally assign a second multi-user conflict ID, e.g., 2, based on the first multi-user conflict ID, e.g., 1. The second multi-user conflict ID can be assigned for an expected second save event, e.g., for the following user modification. According to some embodiments, the multi-user conflict ID can be sequentially increment interchange control numbers, such as an incremental interchanger. For example, the service provider can automatically add a predetermined number, e.g., +1, to the present multi-user conflict ID to generate the next ID.

Accordingly, the updated template, e.g., template serial No. 5Qtz1wx, is associated with the preassigned first multi-user conflict ID, e.g., 1. The service provider can transmit serialized data related to the updated template, i.e., template serial No. 5Qtz1wx with multi-user conflict ID 1, to a computing device associated with the first user.

Following the first user's “save” action, the service provider can receive an attempted second user modification of the base template, e.g., 4Kxr2aq, which is still associated with the preassigned, expected first multi-user conflict ID, e.g., 1. The service provider can first determine whether the attempted second user modification triggers a “save” event at the service provider. Such a save event can be either an explicit save event, such as delete, move, create a saved block, or update block settings, or an implied save event as explained herein. When the second user's modification is minor, a save event is not triggered and then the conflict action resolution process will not initiate.

When the save event is triggered, the service provider can compare the received multi-user conflict ID, i.e., 1, with the assigned and expected multi-user conflict ID, i.e., 2. As the received multi-user conflict ID, i.e., 1, is lower than the expected multi-user conflict ID, i.e., 2, the service provider can conclude a potential editing conflict exists. Accordingly, the service provider can initiate the conflict resolution process as described in FIG. 6. The service provider can determine and implement a proper conflict resolution action at least based on the conflict resolution model. Examples of conflict resolution actions can be a conflict warning that disregards the second user modification, an acceptance of the second user modification, and an option for action selection by a user.

In particular, when an editing conflict is resolvable, the service provider can adopt the second user's modification by updating its associated base template from serial No. 4Kxr2aq to serial No. 7Wxi4zu, which comprises both user's modifications. It can further assign a new multi-user conflict ID for the next user action, e.g., 3, which is associated with template No. 7Wxi4zu. According to some embodiments, the service provider can prompt the second user to select whether to implement his/her modification or to keep the first user's modification. Furthermore, the service provider can transmit serialized data related to the updated template, i.e., template serial No. 7Wxi4zu with multi-user conflict ID 3, to the second user's computing device.

When an editing conflict is unresolvable, the service provider can deny the second user's modification. It can show a warning on the second user's computing device. It can further transmit serialized data related to the revised base template, i.e., template serial No. 5Qtz1wx, with the second multi-user conflict ID, i.e., 2, to the second user's computing device. This way, the second user's editing copy of the base template is updated to reflect the first user's modification.

According to some embodiments, the service provider can serialize structured data of each version of the template, using for example, JSON (JavaScript Object Notation) strings. Serialization is to convert an object into data strings, and deserialization is to convert string into objects.

According to some embodiments, the service provider can generate additional metadata to facilitate template serialization. For example, the service provider can record client ID, timestamp information related to each save or attempted save event of the template.

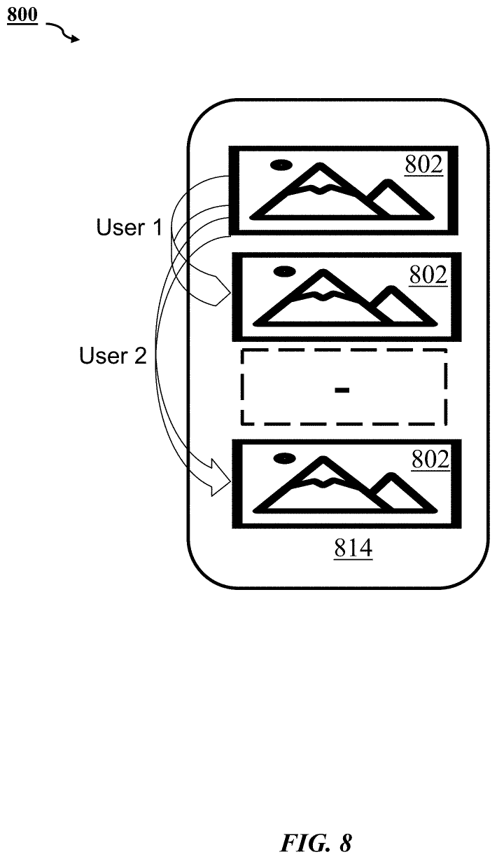

FIG. 8 is an exemplary view of an email with multi-user editing with a conflict resolution process, which illustrates features consistent with some implementations of the present subject matter. A base template 814 can comprise an image block 802. A first user can, via a computing device, move image block 802 from its first position to a second position. As described herein, a service provider can update base template 814 to an updated template to reflect the move. Following the move of image block 802, the service provider can receive a requested move of image block 802 from its first position to a third position by a second user. As the multi-user conflict ID associated with the requested move is lower than the preassigned ID, a potential editing conflict exists. The service provider can determine, based on the conflict resolution model of FIG. 6, that the editing conflict is resolvable. As such, the service provider can move image block 802 to a third position, as indicated in FIG. 8. According to some embodiments, the service provider can prompt the second user to select whether to keep the first user's modification or to overwrite it. In addition, the service provider can update base template 814 and transmit the related data to the second user. According to some embodiments, the service provider can correspondingly update the base template 814 associated with the first user's computing device to reflect image block 802's third position.

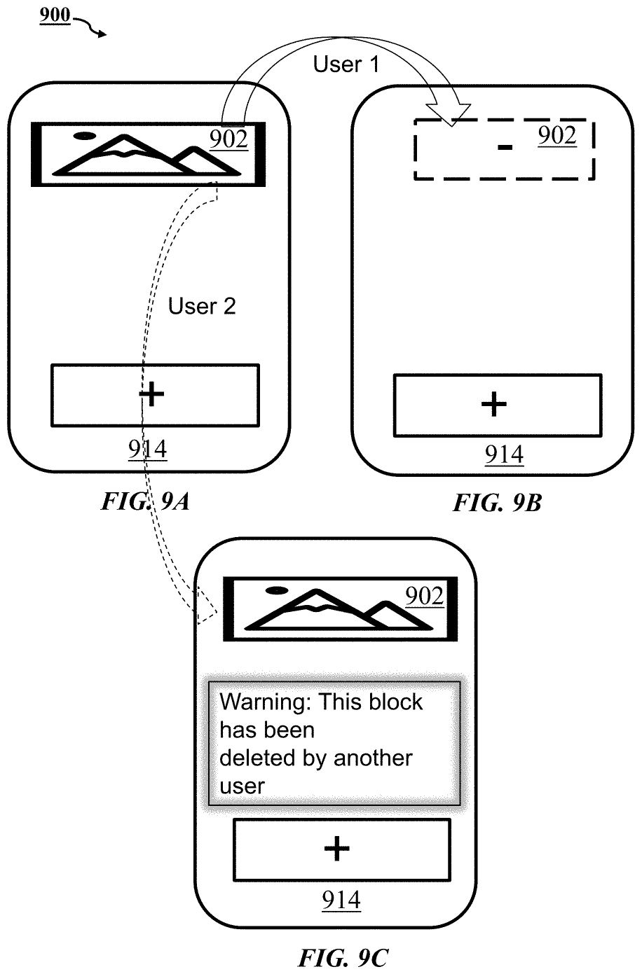

FIGS. 9A, 9B and 9C are exemplary views of an email with multi-user editing with a conflict resolution process, which illustrates features consistent with some implementations of the present subject matter. As shown in FIG. 9A, a base template 914 can comprise an image block 902. As shown in FIG. 9B, a first user can, via a computing device, delete image block 902. Following the deletion of image block 902, the service provider can receive a requested move of image block 902 by a second user. As the multi-user conflict ID associated with the requested move is lower than the preassigned ID, a potential editing conflict exists. The service provider can determine, based on the conflict resolution model of FIG. 6, that the editing conflict is unresolvable. Accordingly, the requested move of image block 902 by the second user is denied. As shown in FIG. 9C, the service provider can further display a warning to the second user, e.g., “this block has been deleted by another user.”

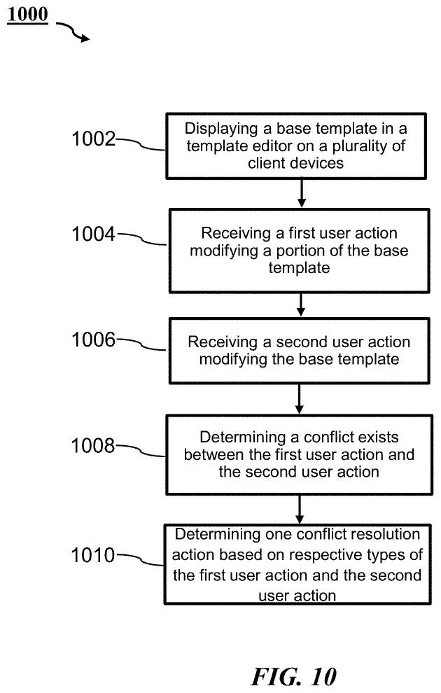

FIG. 10 is an exemplary flow diagram illustrating aspects of a method having features consistent with some implementations of the present subject matter. At step 1002, a service provider can display a base template on one or more client devices. The base template can comprise one or more blocks representing a structure of an email. According to some embodiments, a template editor can comprise one or more email templates. It enables a user to drag-and-drop a selected template to an email canvas for further customization.

At step 1004, the service provider can receive a first user modification of the base template configured to trigger a first save event. According to some embodiments, the saved event can be one of a delete, move, create a saved/universal block, or update block settings. According to some embodiments, the saved event can be an implied event, for example, the user left an edited block setting without saving it. The service provider can update the base template based on the first user modification.

At step 1006, the service provider can receive a second user modification of the original base template to trigger an attempted second save event. The attempted second save event can be one of a delete, move, create a saved/universal block, or update block settings. According to some embodiments, the attempted second save event can be an implied event, for example, the user left an edited block setting without saving it.

At step 1008, the service provider can determine an editing conflict exists between the first user modification and the second user modification. For example, a multi-user conflict ID can be adopted to determine whether an editing conflict exists. In particular, the service provider can determine an editing conflict exists between the first user modification and the second user modification based on whether the proposed multi-user conflict ID is lower than the second multi-user conflict ID.

At step 1010, the service provider can determine one or more conflict resolution actions at least based on a conflict resolution model. A conflict resolution model can be generated based on the logic of the conflict action table. The conflict resolution model, for example, can comprise algorithms, programs, and codes to implement functions as described herein. According to some embodiments, at least part of the conflict resolution model can be implemented by one or more servers within a cloud-processing structure, such as by a third-party service provider through a web API. According to some embodiments, at least partial of the conflict resolution model can be implemented by a “local” computing device located in a private network or by a hybrid processing structure.

According to some embodiments, when editing conflict is unresolvable, the service provider can reject the second user modification and transmit the updated template to the second user's computing device. According to some embodiments, when the editing conflict is resolvable, the service provider can incorporate both user's modifications. Furthermore, the service provider can provide an option, allowing the second user to decide whether to implement his/her modification over the first user's modification.

According to some embodiments, the service provider can partially lock one block edition in the bast template on one or more client devices. The service provider can also allow minor editions of a block.

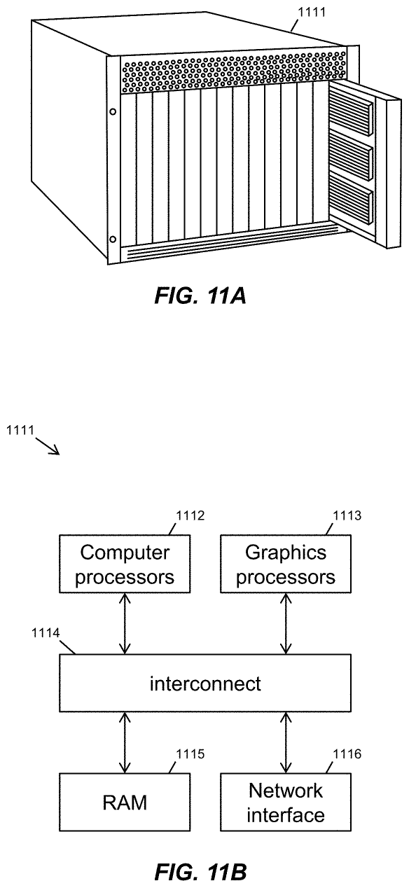

FIG. 11A shows a cloud server according to one or more embodiments of the present subject matter. FIG. 11A shows a picture of a server system 1111 in a data center with multiple blades that can be used to implement one or multiple aspects of the present subject matter.

FIG. 11B shows a diagram of a cloud server according to one or more embodiments of the present subject matter. Server system 1111 comprises one or more clusters of central processing units (CPU)1112 and one or more clusters of graphics processing units (GPU) 1113. Various implementations may use either or both of CPUs and GPUs.

According to some embodiments, the CPUs 1112 and GPUs 1113 are connected through an interconnect 1114 to random access memory (RAM) devices 1115. RAM devices can store temporary data values, software instructions for CPUs and GPUs, operating system software, and other data necessary for system operation.

The server system 1111 further comprises a network interface 816 connected to the interconnect 1114. The network interface 1116 transmits and receives data from computing devices and host devices such as text editing data necessary for system operation.

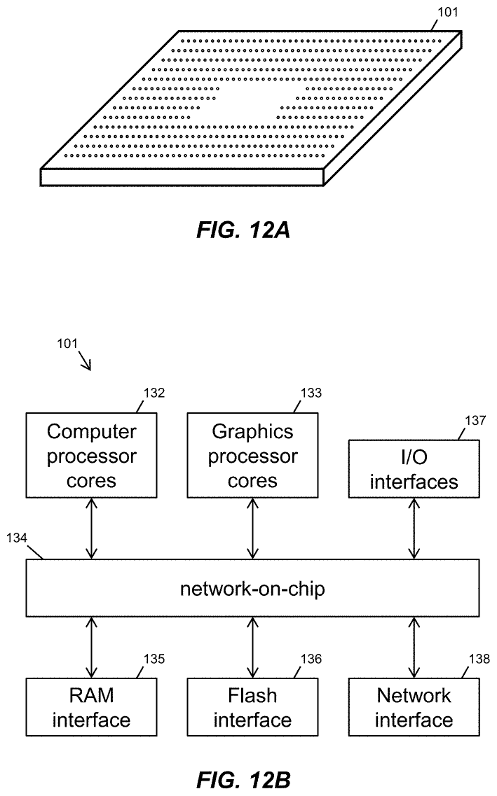

FIG. 12A shows a packaged system-on-chip according to one or more embodiments of the present subject matter. FIG. 12A shows the bottom side of a packaged system-on-chip device 121 with a ball grid array for surface-mount soldering to a printed circuit board. Various package shapes and sizes can be utilized for various SoC implementations.

FIG. 12B shows a diagram of a system-on-chip according to one or more embodiments of the present subject matter. FIG. 12B shows a block diagram of the system-on-chip 121. It comprises a multicore cluster of CPU cores 132 and a multicore cluster of GPU cores 133. The processors connect through a network-on-chip 134 to an off-chip dynamic random access memory (DRAM) interface 135 for volatile program and data storage and a Flash interface 136 for non-volatile storage of computer program code in a Flash RAM non-transitory computer-readable medium. SoC 131 may also have a display interface (not shown) for displaying a graphical user interface for functions such as displaying an ASR transcription to a user or displaying the results of a virtual assistant command and an I/O interface module 137 for connecting to various I/O interface devices, as needed for different peripheral devices. The I/O interface enables sensors such as touch screen sensors, geolocation receivers, microphones, speakers, Bluetooth peripherals, and USB devices, such as keyboards and mice, among others. SoC 131 also comprises a network interface 1038 to allow the processors to access the Internet through wired or wireless connections such as WiFi, 3G, 4G long-term evolution (LTE), 5G, and other wireless interface standard radios as well as Ethernet connection hardware. By executing instructions stored in RAM devices through interface 135 or Flash devices through interface 136, the CPUs 132 and GPUs 133 perform steps of methods as described herein.

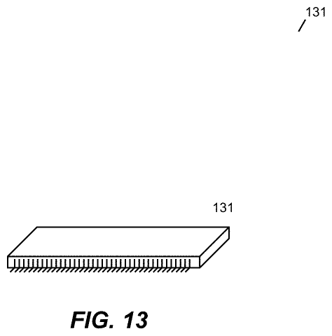

FIG. 13 shows a non-transitory computer-readable medium according to one or more embodiments of the present subject matter. Program code, data, operating system code, and other necessary data are stored by non-transitory computer-readable media.

FIG. 13 shows an example computer-readable medium 131 that is a Flash random access memory (RAM) chip. Data centers commonly use Flash memory to store data and code for server processors. Mobile devices commonly use Flash memory to store data and code for processors within SoCs. Non-transitory computer-readable medium 131 stores code comprising instructions that, if executed by one or more computers, would cause the computers to perform steps of methods described herein. Other digital data storage media can be appropriate in various applications.

Examples shown and described use certain spoken languages. Various implementations operate similarly for other languages or combinations of languages. Some embodiments are screenless, such as an earpiece, which has no display screen. Some embodiments are stationary, such as a vending machine. Some embodiments are mobile, such as an automobile. Some embodiments are portable, such as a mobile phone. Some embodiments may be implanted in a human body. Some embodiments comprise manual interfaces such as keyboards or touchscreens. Some embodiments comprise neural interfaces that use human thoughts as a form of natural language expression.

Several aspects of one implementation of the present subject matter are described. However, various implementations of the present subject matter provide numerous features including, complementing, supplementing, and/or replacing the features described above. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Practitioners skilled in the art will recognize many modifications and variations. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A computer-implemented method for multi-user document editing, comprising:
receiving, at a first client device, a base template from a service provider, wherein the base template is associated with a proposed first multi-user conflict ID assigned for a first save event;
modifying, at the first client device, the base template with a first user modification to generate a first template associated with the proposed first-user conflict ID;
transmitting the first template and the proposed first multi-user conflict ID to the service provider,
determining, at the service provider, whether an editing conflict exists between the first user modification and a second user modification based on whether the proposed first multi-user ID is lower than an assigned multi-user conflict ID;
generating a confirmation of the proposed first multi-user conflict ID, when the proposed first multi-user ID is the same as the assigned multi-user conflict ID; and
generating a rejection of the proposed first multi-user conflict ID and an updated base template with serialization data in association with the assigned multi-user conflict ID, when the proposed first multi-user ID is lower than the assigned multi-user conflict ID.

2. The computer-implemented method of claim 1, further comprising:
determining, when the editing conflict exists, at least one conflict resolution action at least based on a conflict resolution model; and
implementing the at least one conflict resolution action.

3. The computer-implemented method of claim 2, wherein the at least one conflict resolution comprises one of a conflict warning that disregards the first user modification, an acceptance of the first user modification, and an option for action selection by the first user.

4. The computer-implemented method of claim 1, further comprising:
tracking and serializing each modification applying to the base template.

5. A computer-implemented method for multi-user document editing, comprising:
displaying, by a service provider, a base template on a plurality of client devices, wherein the base template is associated with a first multi-user conflict ID assigned for a first save event;
receiving, from a first client device, a first user modification of the base template configured to trigger the first save event;
updating, at the service provider, the base template to generate a first template associated with the first multi-user conflict ID and incrementally generating a second multi-user conflict ID based on the first multi-user conflict ID, wherein the second multi-user conflict ID is assigned for a second save event;
receiving, from a second client device, a second user modification of the base template to trigger an attempted second save event, wherein the second user modification is associated with a proposed multi-user conflict ID;
determining an editing conflict exists between the first user modification and the second user modification based on whether the proposed multi-user conflict ID is lower than the second multi-user conflict ID;
determining, when the editing conflict exists, at least one conflict resolution action at least based on a conflict resolution model; and
implementing the at least one conflict resolution action.

6. The computer-implemented method of claim 5, further comprising:
transmitting the first template with serialization data associated with the first multi-user conflict ID to the first client device.

7. The computer-implemented method of claim 5, wherein the at least one conflict resolution comprises one of a conflict warning that disregards the second user modification, an acceptance of the second user modification, and an option for action selection by a user.

8. The computer-implemented method of claim 5, further comprising:
when the editing conflict is resolvable, updating the first template to generate a second template associated with the second multi-user conflict ID and incrementally generating a third multi-user conflict ID based on the second multi-user conflict ID, wherein the third multi-user conflict ID is assigned for a third save event; and
transmitting the second template with serialization data associated with the second multi-user conflict ID to the second client device associated with the second user modification.

9. The computer-implemented method of claim 5, further comprising:
when the editing conflict is unresolvable, rejecting the second user modification; and
transmitting the first template with serialization data associated with the first multi-user conflict ID to the second client device associated with the second user modification.

10. The computer-implemented method of claim 5, further comprising:
displaying a plurality of templates in a template editor; and
enabling a drag-and-drop of a selected template from the plurality of templates as the base template.

11. The computer-implemented method of claim 5, wherein the base template comprises one or more blocks representing a structure of an email.

12. The computer-implemented method of claim 5, wherein each of the first save event and the second save event comprises at least one of a move, a deletion, a creation of a block and a block setting edition.

13. The computer-implemented method of claim 5, wherein each of the first save event and the second save event comprises a change on a sidebar of the base template and a following confirmation.

14. The computer-implemented method of claim 5, further comprising:
during a save event, partially locking at least one block edition in the base template displayed on the plurality of client devices, wherein the at least one block edition comprises an addition, a deletion, or a move of a block and a block setting edition.

15. The computer-implemented method of claim 14, further comprising:
during the save event, partially allowing at least one minor block edition in the base template, wherein the at least one minor block edition comprises an edition of a block.

16. The computer-implemented method of claim 5, further comprising:
tracking and serializing each modification applying to the base template.

17. A computer-implemented method for multi-user document editing, comprising:
displaying, by a service provider, a base template on a plurality of client devices;
receiving, from a first client device, a first user modification of the base template configured to trigger a first save event;
updating the base template to generate a first template;
receiving, from a second client device, a second user modification of the base template to trigger an attempted second save event;
determining an editing conflict exists between the first user modification and the second user modification;
determining at least one conflict resolution action at least based on a conflict resolution model; and
implementing the at least one conflict resolution action.

18. The computer-implemented method of claim 17, wherein the at least one conflict resolution comprises one of a conflict warning that disregards the second user modification, an acceptance of the second user modification, and an option for action selection by a user.

19. The computer-implemented method of claim 17, further comprising:
when the editing conflict is resolvable, updating the first template to generate a second template; and
transmitting the second template with serialization data to the second client device associated with the second user modification.

20. The computer-implemented method of claim 17, further comprising:
when the editing conflict is unresolvable, rejecting the second user modification; and
transmitting the first template with serialization data to the second client device associated with the second user modification.
